(19) United States
(12) Patent Application Publication
(10) Pub. No.: US 2025/0256800 A1
(43) Pub. Date: Aug. 14, 2025

(54) BICYCLE FRONT FORKS WITH STEERER TUBES HAVING MARKINGS

(71) Applicant: SRAM, LLC, CHICAGO, IL (US)

(72) Inventors: MICHAEL MAXWELL, COLORADO SPRINGS, CO (US); ALEXANDER ROSENBERRY, COLORADO SPRINGS, CO (US); KENNY CHEN, TAICHUNG CITY (TW); JAMES DONAHUGH, COLORADO SPRINGS, CO (US); TREY REIN, COLORADO SPRINGS, CO (US)

(73) Assignee: SRAM, LLC, CHICAGO, IL (US)

(21) Appl. No.: 18/437,731

(22) Filed: Feb. 9, 2024

(51) Int. Cl. B62K 21/18; B62K 21/04

(52) U.S. Cl. CPC B62K 21/18; B62K 21/04

(57) ABSTRACT

An example front fork for a bicycle disclosed herein includes a crown having a top side and a bottom side opposite the top side. The front fork includes at least one leg coupled to and extending downward from the bottom side of the crown. The front fork also includes a steerer tube coupled to and extending upward from the top side of the crown. The steerer tube includes first and second markings on an outer surface of the steerer tube. The first marking indicates a distance between the first marking and the top side of the crown to enable a user to cut the steering tube to a desired length. The first marking extends in a circumferential direction on the outer surface. The second marking is used to align a stem or handlebars on the steerer tube. The second marking extends in an axial direction and intersects the first marking.

### FIELD OF THE DISCLOSURE

This disclosure relates generally to bicycle components and, more particularly, to bicycle front forks with steerer tubes having markings.

### BACKGROUND

Bicycles are known to have front forks. A front fork typically includes a steerer tube, a crown, and first and second legs. The first and second legs extend downward from the crown and are coupled to the hub or axle of the front wheel. The steerer tube extends upward from the crown and is installed through a head tube on the bicycle frame and coupled to the handlebars. Typically, front forks are manufactured with a steerer tube that is longer than necessary for a given bicycle. When a user receives a new front fork, the user cuts the steerer tube to a desired length based on the height of the head tube and the rider's desired handlebar height. After inserting the steerer tube through the head tube, the user connects the handlebars to the top portion of the steerer tube via a stem. The user aligns the handlebars with the front wheel before tightening the stem.

### SUMMARY

An example front fork for a bicycle disclosed herein includes a crown having a top side and a bottom side opposite the top side. The example front fork includes at least one first leg coupled to and extending downward from the bottom side of the crown. The example front fork also includes a steerer tube coupled to and extending upward from the top side of the crown. The steerer tube includes a first marking and a second marking on an outer surface of the steerer tube. The first marking indicates a distance between the first marking and the top side of the crown to enable a user to cut the steering tube to a desired length. The first marking extends in a circumferential direction on the outer surface of the steerer tube. The second marking to be used to align at least one of a stem or handlebars on the steerer tube. The second marking extends in an axial direction and intersects the first marking.

An example front fork for a bicycle disclosed herein includes a crown having a top side and a bottom side opposite the top side. The example front fork includes at least one first leg coupled to and extending downward from the bottom side of the crown. The example front fork also includes a steerer tube coupled to and extending upward from the top side of the crown. The steering tube having a marking on an outer surface of the steerer tube. The marking to be used to align at least one of a stem or handlebars on the steerer tube. The marking comprises a line extending in an axial direction along the outer surface of the steerer tube such that the line is visible in a gap between ends of the stem when the stem is installed on the steerer tube.

### BRIEF DESCRIPTION OF THE DRAWINGS

FIG. 1 is a side view of an example bicycle that can employ example front forks disclosed herein.

FIG. 2A is a rear side view of an example front fork with an example steerer tube with example markings that can be implemented on the example bicycle of FIG. 1.

FIG. 2B is a side view of the example front fork of FIG. 2A.

FIG. 3 is an enlarged view of the callout in FIG. 2A showing the example markings on the example steerer tube.

FIG. 4 is a side view of the example steerer tube of the example front fork of FIG. 2A and an example handlebar stem connected to the example steerer tube.

FIGS. 5A and 5B are perspective views showing an example process of assembling the example front fork and example handlebars on the example bicycle of FIG. 1.

FIG. 6A is a rear side view of the example steerer tube and the example stem of FIG. 4.

FIG. 6B is an enlarged view of the callout of FIG. 6A.

FIG. 7A is a top view of the example front fork of FIG. 2A, an example stem, and example handlebars installed on the example bicycle of FIG. 1.

FIG. 7B is a rear perspective view of the front fork, the example stem, and the example handlebars of FIG. 7A.

FIG. 7C is an enlarged view of the callout of FIG. 7B.

The figures are not to scale. Instead, the thickness of the layers or regions may be enlarged in the drawings. In general, the same reference numbers will be used throughout the drawing(s) and accompanying written description to refer to the same or like parts.

Descriptors “first,” “second,” “third,” etc. are used herein when identifying multiple elements or components that may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Disclosed herein are example front forks for a bicycle that include a crown having a top side and a bottom side opposite the top side. The example front fork includes at least one leg coupled to and extending downward from the bottom side of the crown. The example front fork also includes a steerer tube coupled to and extending upward from the top side of the crown. The steerer tube includes a marking on the outer surface of the steerer tube. The marking is used to indicate a characteristic of the front fork. In some examples, the marking is used to indicate a distance between the marking and the top side of the crown to enable a user to cut the steerer tube to a desired length. Providing a marking to indicate the distance between the marking and the top side of the crown eliminates the need for a user to dry-fit the front fork and handlebar assembly and estimate the length of the steerer tube to cut. Instead, in the example steerer tubes disclosed herein, the user may utilize the marking on the steerer tube to assist in cutting the steerer tube to a desired length. In some examples, the steerer tube includes multiple markings, which are spaced at a certain increment, such as every 10 millimeters (mm), every 20 mm, etc.

Also disclosed herein are markings on the steerer tube that can be used to assist the user in aligning the stem on the steerer tube, so that the handlebars are aligned with the front wheel on the bicycle. For example, the marking may be a vertical line on the rear side of the steerer tube. When connecting the handlebar stem to the steerer tube, the arms on the stem can be aligned on opposite sides of the vertical line before tightening the stem onto the steerer tube. This ensures the handlebars are perpendicular to the front wheel and/or otherwise align with the front axle of front wheel. Therefore, the example steerer tubes disclosed herein can allow a user to cut more precisely the preferred length of the steerer tube and/or align the steerer tube with the handlebars on the bicycle. In some examples, the marking(s) are formed directly on the outer surface of the steerer tube, such as by etching, engraving or any other method of removing material from the outer surface of the steerer tube. Additionally or alternatively, the markings(s) can be paint, a sticker, a decal, a pre-finish masking, and/or another type of material applied or added to the outer surface of the steerer tube.

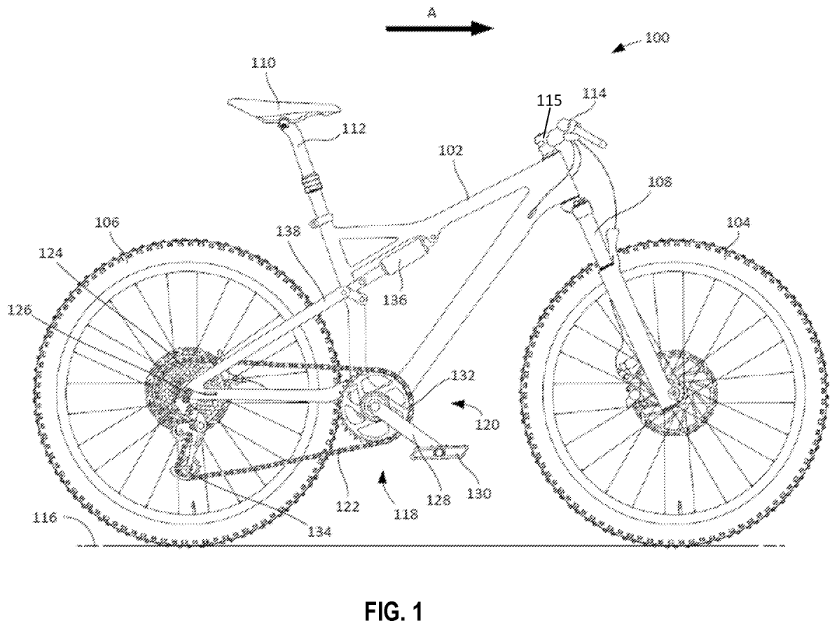

Turning now to the figures, FIG. 1 illustrates one example of a human powered vehicle on which the example front forks with marked steerer tubes disclosed herein may be implemented. In this example, the vehicle is one possible type of bicycle 100, such as a mountain bicycle. In the illustrated example, the bicycle 100 includes a frame 102 and a front wheel 104 and a rear wheel 106 rotatably coupled to the frame 102. In the illustrated example, the front wheel 104 is coupled to the front end of the frame 102 via a front fork 108. A front and/or forward riding direction or orientation of the bicycle 100 is indicated by the direction of the arrow A in FIG. 1. As such, a forward direction of movement for the bicycle 100 is indicated by the direction of arrow A. The terms “upper,” “lower,” “top,” “bottom,” “rear,” “front,” “fore,” “aft,” “vertical,” “horizontal,” “right,” “left,” “inboard,” “outboard” and variations or derivatives thereof, refer to the orientations of the exemplary bicycle 100, shown in FIG. 1, from the perspective of a user seated thereon.

In the illustrated example of FIG. 1, the bicycle 100 includes a seat 110 coupled to the frame 102 (e.g., near the rear end of the frame 102 relative to the forward direction A) via a seat post 112. The bicycle 100 also includes handlebars 114 coupled to the front fork 108 for steering the bicycle 100. The handlebars 114 are coupled to the front fork 108 by a stem 115. The bicycle 100 is shown on a riding surface 116. The riding surface 116 may be any riding surface such as the ground (e.g., a dirt path, a sidewalk, a street, etc.), a man-made structure above the ground (e.g., a wooden ramp), and/or any other surface.

In the illustrated example, the bicycle 100 has a drivetrain 118 that includes a crank assembly 120. The crank assembly 120 is operatively coupled via a chain 122 to a sprocket assembly 124 mounted to a hub 126 of the rear wheel 106. The crank assembly 120 includes at least one, and typically two, crank arms 128 and pedals 130, along with at least one front sprocket, or chainring 132. A rear gear change device 134, such as a derailleur, is disposed at the rear wheel 106 to move the chain 122 through different sprockets of the sprocket assembly 124. Additionally or alternatively, the bicycle 100 may include a front gear change device to move the chain 122 between a plurality of chainrings 132.

The example bicycle 100 can include a suspension system having one or more suspension components. For example, the front fork 108 can be implemented as a front suspension component that integrates a spring and/or a damper. Further, in the illustrated example, the bicycle 100 includes a rear suspension component 136, which is a shock absorber, referred to herein as the rear shock absorber 136. The rear shock absorber 136 is coupled between two portions of the frame 102, including a swing arm 138 coupled to the rear wheel 106. The front fork 108 and the rear shock absorber 136 absorb shocks and vibrations while riding the bicycle 100 (e.g., when riding over rough terrain). In other examples, the front fork 108 and/or the rear shock absorber 136 may be integrated into the bicycle 100 in other configurations or arrangements. Further, in other examples, the suspension system may employ only one suspension component (e.g., only the front fork 108) or more than two suspension components (e.g., an additional suspension component on the seat post 112) in addition to or as an alternative to the front fork 108 and rear shock absorber 136.

While the example bicycle 100 depicted in FIG. 1 is a type of mountain bicycle, the example front forks disclosed herein can be implemented on other types of bicycles. For example, the disclosed front forks may be used on road bicycles, as well as bicycles with mechanical (e.g., cable, hydraulic, pneumatic, etc.) and non-mechanical (e.g., wired, wireless) drive systems. The disclosed front forks can also be implemented on other types of two-wheeled, three-wheeled, and four-wheeled human powered vehicles. Further, the example fork forks can be used on other types of vehicles, such as motorized vehicles (e.g., a motorcycle).

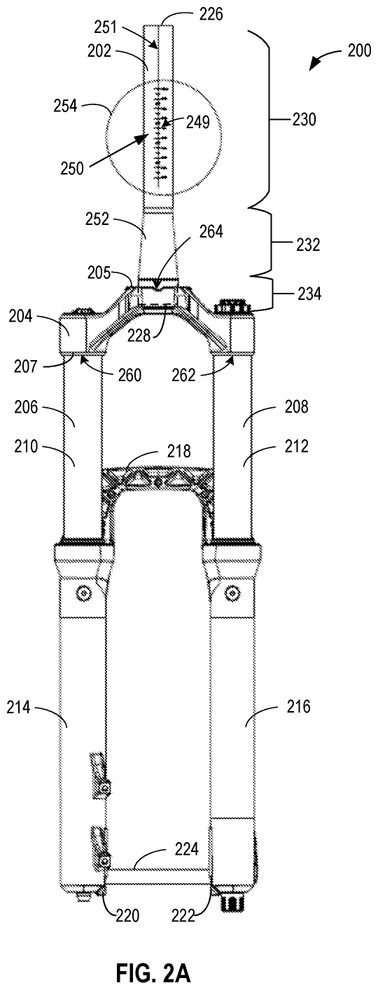

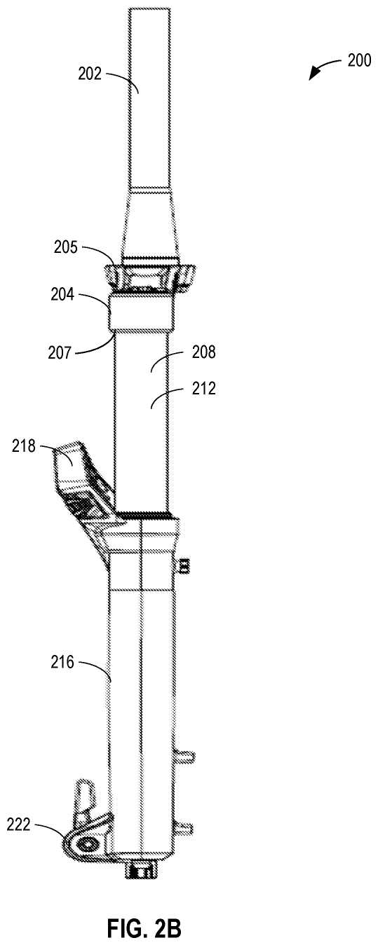

FIG. 2A is a rear side view of an example front fork 200 (referred to herein as the fork 200) that can be implemented as the front fork 108 on the bicycle 100 of FIG. 1, and FIG. 2B is a side view (e.g., a left side) of the example fork 200. When the fork 200 is installed on the bicycle 100, the rear side shown in FIG. 2A is the side facing the rear wheel 106 (FIG. 1). In the illustrated example, the fork 200 includes a steerer tube 202, a crown 204, a first leg 206, and a second leg 208. Alternatively, the fork 200 may only include one leg. The crown 204 includes first and second bores 260, 262 extending therethrough for receiving the first and second legs 206, 208, respectively. The crown 204 has a top side 205 and a bottom side 207 opposite the top side 205. As shown in FIGS. 2A and 2B, the crown 204 includes a third bore 264 extending therethrough and disposed between the first and second bores 260, 262 for receiving the steerer tube 202. The steerer tube 202 is coupled to the crown 204 and extends outward (e.g., upward) from the top side 205 of the crown 204, and the first and second legs 206, 208 are coupled to the crown 204 and extend outward (e.g., downward) from the bottom side 207 of the crown 204 opposite the steerer tube 202. As shown in FIG. 2B, the steerer tube 202 is offset in a lateral direction (e.g., rearward) from the legs 206, 208. When the fork 200 is installed on the bicycle 100, the steerer tube 202 extends through an opening in the frame 102 (commonly referred to the head tube), and the handlebars 114 (FIG. 1) are coupled (e.g., clamped, bolted) to a top portion of the steerer tube 202 via the stem 115 (FIG. 1). The steerer tube 202 is coupled to the crown 204 in a non-rotatable manner. For example, the steerer tube 202 can be coupled to the crown 204 via welding, press fit, threaded fasteners and/or other mechanical and/or chemical techniques. As such, when a rider turns the handlebars 114 (FIG. 1), the steerer tube 202 rotates the crown 204 to turn the front wheel 104 (FIG. 1). In some examples, the steerer tube 202, the crown 204, and/or the legs 206, 208 are constructed of metal, such as aluminum, steel, stainless steel, or carbon fiber. In other examples, the steerer tube 202, the crown 204, and/or the legs 206, 208 can be constructed of other materials.

In this example, the fork 200 is a suspension fork that includes telescoping legs. However, the steerer tube 202 with markings of this disclosure may be implemented on forks having fixed legs that do not telescope, such as on rigid fork configurations used on road bicycles, etc. As shown in FIG. 2A, the first and second legs 206, 208 include first and second upper tubes 210, 212 (sometimes referred to as leg portions or stanchions), respectively, and first and second lower tubes 214, 216 (sometimes referred to as leg portions or lowers), respectively. The first and second upper tubes 210, 212 may be collectively referred to as an upper tube assembly, and the first and second lower tubes 214, 216 may be collectively referred to as a lower tube assembly. The first and second upper tubes 210, 212 are coupled to and extend downward from the crown 204. In some examples, the first and second lower tubes 214, 216 are coupled via an arch 218 (sometimes referred to as a fork brace or stabilizer). The first and second lower tubes 214, 216 include respective front wheel attachment portions 220, 222, such as holes (e.g., eyelets) or dropouts, for attaching the front wheel 104 (FIG. 1) to the fork 200. FIG. 2A shows an example axle 224 that extends through a hub of the front wheel 104 (FIG. 1) and is connected at the front wheel attachment portions 220, 222. The first and second upper tubes 210, 212 are slidably received within the respective first and second lower tubes 214, 216. Thus, the first and second upper tubes 210, 212 form a telescopic arrangement with the respective first and second lower tubes 214, 216. In some examples, a spring (e.g., an air spring) is disposed in one of the legs 206, 208 and a damper is disposed in the other one of the legs 206, 208. The spring and damper control the movement of the first and second lower tubes 214, 216 relative to the first and second upper tubes 210, 212 to absorb impacts and vibrations. During a compression stroke, the first and second upper tubes 210, 212 move into or toward the respective first and second lower tubes 214, 216, and during a rebound stroke, the first and second upper tubes 210, 212 move out of or away from a respective first and second lower tubes 214, 216.

In the illustrated example of FIG. 2A, the steerer tube 202 has a first end 226 and a second end 228 (shown by dashed lines) opposite the first end 226. The first end 226 is the top or distal end of the steerer tube 202. In this example, the steerer tube 202 has a first portion 230 that is straight, a second portion 232 that is tapered, and a third portion 234 that is straight. The first portion 230 extends between the second portion 232 and the first end 226, and the third portion 234 extends between the second portion 232 and the second end 228. The second portion 232 is tapered to seat against a corresponding surface in the head tube of the frame 102. In this example, the third portion 234 is partially disposed or inserted into the third bore 264 in the crown 204. In some examples, the steerer tube 202 is coupled to the crown 204 by press fitting the third portion 234 into the third bore in the crown 204.

In the illustrated example, the first portion 230 of the steerer tube is relatively long and is typically longer than needed for a given bicycle. Fork manufacturers often sell forks with longer steerer tubes. This enables a user or customer to cut the steerer tube 202 down to the desired length for their bicycle and handlebar height. For example, a user may cut (e.g., via a saw) a few inches from the top of the steerer tube 202.

In the illustrated example, the steerer tube 202 has one or more markings 250 on an outer surface 252 of the steerer tube 202. In some examples, the markings 250 include height or distance indicators or markings 249 that can be used to help a user determine how much of the steerer tube 202 to cut. Additionally or alternatively, the markings 250 can include alignment indicators or markings 251 that can be used to help align the stem and the handlebars on the steerer tube 202, examples of which are disclosed in further detail herein. In the illustrated example, the markings 250 are on the first portion 230 of the steerer tube 202, which is the straight (non-tapered) portion that remains outside of the head tube after the steerer tube 202 is installed. However, in other examples, the markings 250 can be formed on another portion of the steerer tube 202. Further, in other examples, the steerer tube 202 may not have a tapered portion, and instead may be entirely straight between the first and second ends 226, 228. In the illustrated example, the markings 250 are on a rear side of the steerer tube 202, which is the side facing rearward and toward the rider when the fork 200 is installed on the bicycle 100 (FIG. 1). However, in other examples, one or more of the markings 250 can be positioned on another side of the steerer tube 202.

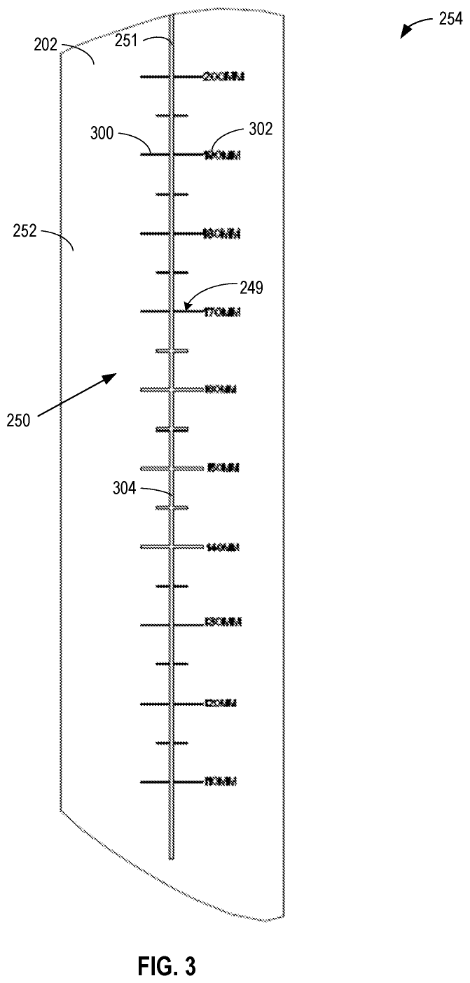

FIG. 3 is an enlarged view of the callout 254 of FIG. 2A showing the distance markings 249 on the steerer tube 202. In this example, the distance markings 249 include a plurality of lines 300 (one of which is referenced in FIG. 3). The lines 300 are spaced from each other in an axial direction along the outer surface 252 of the steerer tube 202. The lines 300 indicate or represent the distance (e.g., height or length) between the respective line 300 and the top side 205 (FIG. 2A) of the crown 204 (FIG. 2A). The distance markings 249 can include any number of lines 300. In some examples, the distance markings 249 may include only one line. However, in other examples, such as shown in FIG. 3, the distance markings 249 can include multiple lines 300.

In the illustrated example, each of the lines 300 extends in a direction (e.g., a horizontal direction) that is perpendicular to an axial direction of the steerer tube 200. For example, the lines 300 extend in a circumferential direction on the outer surface 252. In the example of FIG. 3, the lines 300 are of differing horizontal lengths to indicate various measurement intervals. In particular, the lines 300 alternate between longer lines and shorter lines. However, in other examples, the lines 300 may be the same horizontal length or a variety of differing lengths. In some examples, the lines are spaced apart at a certain increment or interval, such as every 5 mm, every 10 mm, etc. In some examples, the distance markings 249 include one or more numerical values 302 (one of which is referenced in FIG. 3) adjacent to one or more of the lines 300. The numerical values 302 are the measurements for the distances between the respective lines 300 and the top side 205 of the crown 204. For example, the distance markings 249 includes numerical values 302 for 110 mm, 120 mm, 130 mm, 140 mm, 150 mm, 160 mm, 170 mm, 180 mm, 190 mm, and 200 mm. Therefore, in this example, the distance markings 249 provide a range of distances between 110 mm and 200 mm. In other examples, the distance markings 249 can include a larger or smaller range of distances. For example, the distance markings 249 can provide a range of increments between 100 mm-220 mm.

In this example the numerical values 302 are in metric units, but in other examples can be in standard units (e.g., inches) or another unit. In the illustrated example, the numerical values 302 are only adjacent to the longer lines 300, and the shorter lines 300 indicate 5 mm increments between the longer lines 300. However, in other examples, the numerical values 302 may be adjacent to every line 300. While in this example the numerical values 302 indicate a measurement for the distance from the crown 204, in other examples the numerical values 302 may indicate, additionally or alternatively, the relative distance between the lines 300. Further, in other examples, the lines 300 and/or the numerical values 302 may indicate a distance to a position other than the crown 204 (FIG. 2), such as the axle 224 (FIG. 2), the front wheel 104 (FIG. 1), etc. Further, the lines 300 may be of differing lengths, shapes, and/or orientations than those depicted in FIG. 3.

As shown in FIG. 3, the alignment markings 251 include a line 304, which can be used to align the handlebars 114 (FIG. 1) on the steerer tube 202. The line 304 is disclosed in further detail herein.

In some examples, the markings 250, including the lines 300, the numerical values 302, and/or the line 304, may be etched or engraved (i.e., carved) into the outer surface 252 of the steerer tube 202 by removing material. For example, the markings 250 can be formed using a laser, a machining tool (e.g., a bit), or a chemical etching process. For example, the markings 250 can be formed by laser etching the markings 250 into black anodized material of the steerer tube 202. Additionally or alternatively, any of the markings 250 can be formed by at least one of a paint, a sticker, a decal, a pre-finish masking, and/or another type of material applied to the outer surface 252 of the steerer tube 202. For example, the markings 250 can be printed (e.g., via pad printing) onto the outer surface 252 of the steerer tube 202.

The markings 250 may be a first color and at least a portion of the outer surface 252 of the steerer tube 202 where the markings 250 may be a second color different than the first color to improve visibility of the markings 250. The distance markings 249 and the alignment markings 251 may be the same color or different colors. For example, the lines 300 may be the first color and the line 304 may be a third color. The numerical values 302 may be a fourth color. Alternatively, the lines 300 and the numerical values 302 may be the first color and the line 304 is the third color. The first color, the second color, the third color and the fourth color may differ from one another in at least one of brightness, colorfulness and hue.

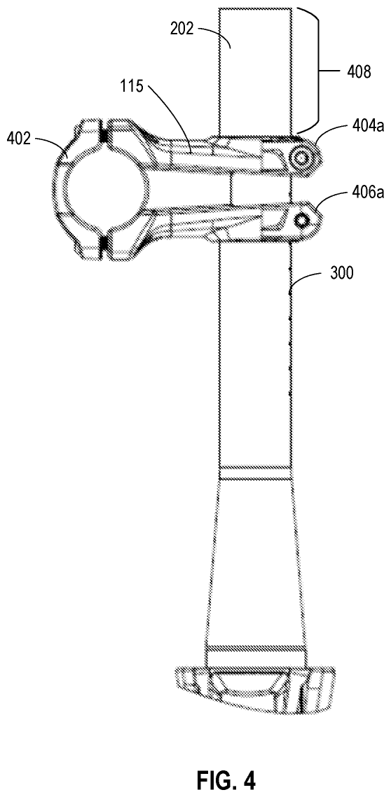

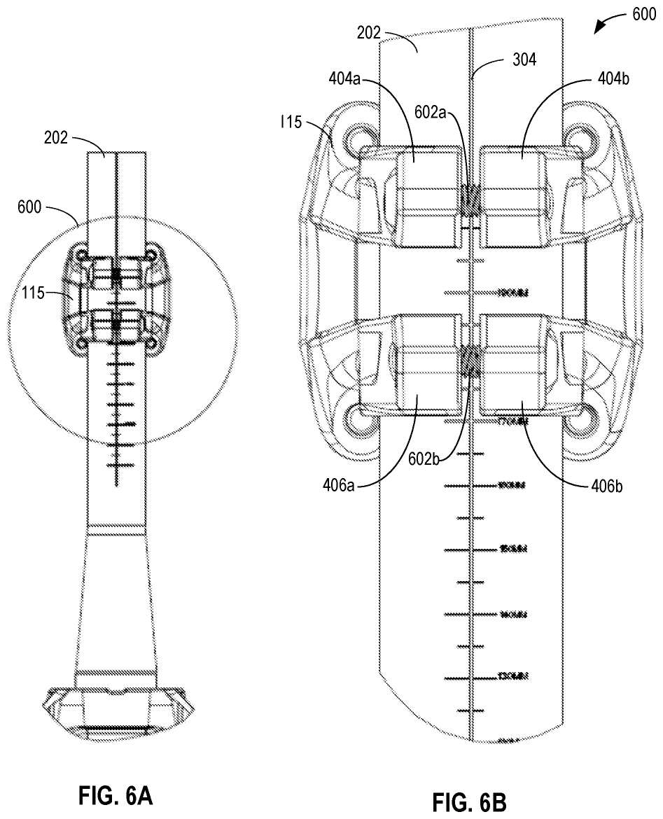

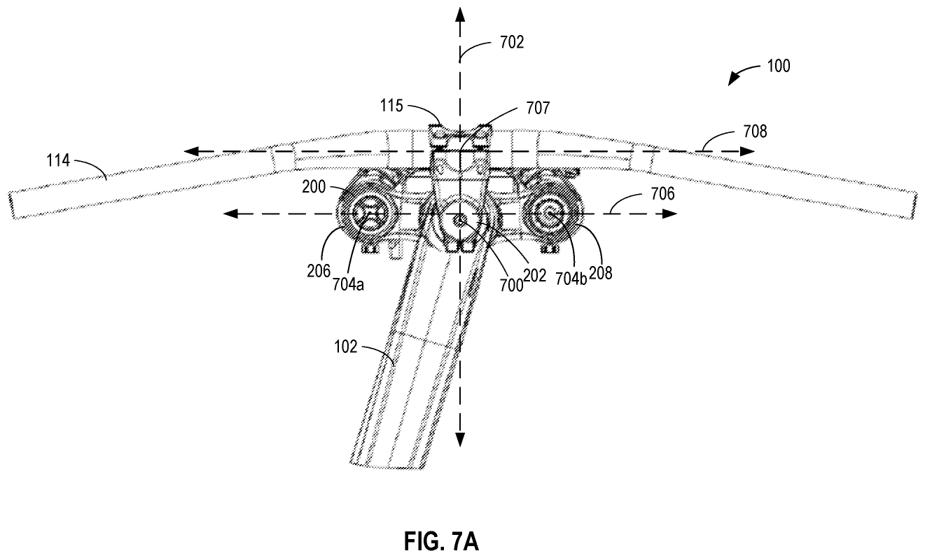

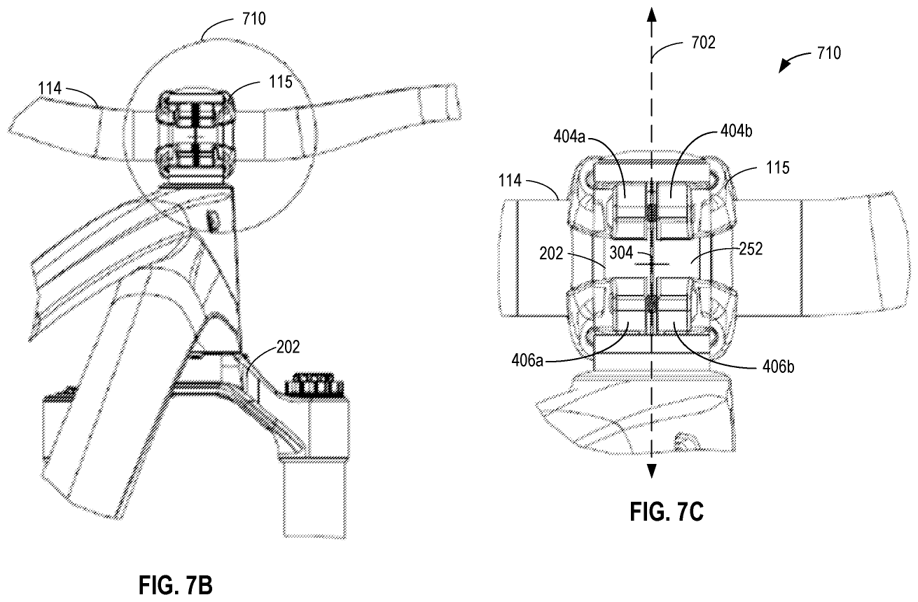

FIG. 4 is a side view showing the stem 115 connected to the steerer tube 202. In the illustrated example, the stem 115 has a first upper arm 404a and a first lower arm 406a that are connected (e.g., via bolts) to second upper and lower arms 404b, 406b (labeled in FIGS. 6B and 7C) on the other side of the steerer tube 202 and can be tightened onto the steerer tube 202. The stem 115 also has a clamp 407 for clamping onto the handlebars 114 (FIG. 1).

The stem 115 is connected to the steerer tube 202 at the desired handlebar height of the user. As shown, a portion 408 of the steerer tube 202 is located above the handlebar attachment 402. This portion 408 may be deemed by the user as excessive length based on the desired height of the handlebars 114 (FIG. 1). Therefore, the user may use the lines 300 to determine how much of the steerer tube 202 to cut off. For example, the user may know their desired handlebar height correspond to the top of the stem 115 being 180 mm from the crown 204. Therefore, the user may cut the steerer tube 202 at or just above the 180 mm marking. As such, the user does not need to assemble the parts, mark the cut location, and disassemble the parts for cutting, as experienced in the past. Further, in some examples, the markings 250 can be used to help the user attach the stem 115 (and, thus, the handlebars 114) at a certain height on the steerer tube 202. In some examples, the handlebars 114 (FIG. 1) may be attached further up or down on the marked steerer tube 202 (FIG. 3A) to adjust the height of the handlebars 114 (FIG. 1).

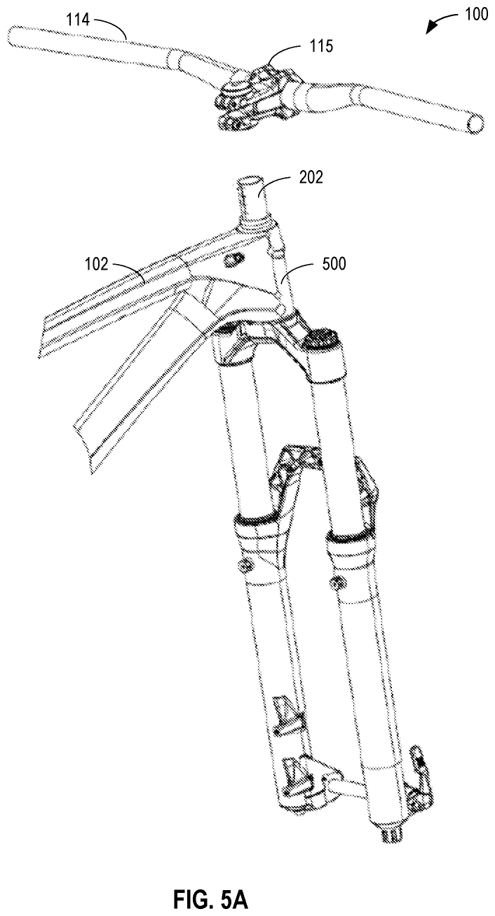

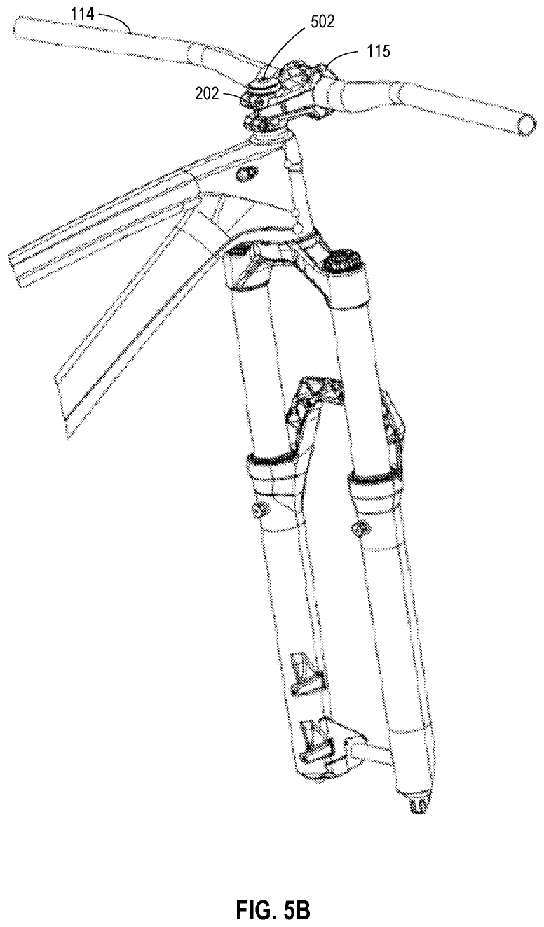

FIG. 5A shows the steerer tube 202 after being cut to a desired length. As compared to the steerer tube 202 of FIG. 4, the steerer tube 202 of FIG. 5A is shorter in length. As shown in FIG. 5A, the steerer tube 202 has been inserted through a head tube 500 on the frame 102 of the bicycle 100. The handlebars 114 can then be connected, via the stem 115, to the portion of the steerer tube sticking upward from the head tube 500.

FIG. 5B shows the handlebars 114 attached via the stem 115 to the steerer tube 202. As compared to the steerer tube 202 of FIG. 4, the steerer tube 202 of this example does not extend as far above the stem 115. Instead, only a small amount (e.g., 3-5 mm) of the steerer tube 202 extends above the stem 115. In this example, a cap 502 is coupled to the top end of the steerer tube 202 to close off the steerer tube 202. In some examples, the stem 115 is spaced from the top of the head tube 500. In some examples, one or more spacers can be used to space the stem 115 from the top of the head tube 500.

Referring back to FIG. 3, one or more of the alignment markings 251 can be used to help align the handlebars 114 on the steerer tube 202 to ensure the handlebars 114 are properly aligned with the front wheel 104 (FIG. 1). In the illustrated example, the alignment markings 251 include a line 304. The line 304 is a vertical line that extends in an axial direction along the outer surface 252 of the steerer tube 202. In this example, the line 304 is positioned along a center plane extending through the steerer tube 202. As such, the line 304 indicates the center of the steerer tube 202. The line 304 enables the user to center the handlebars 114 (FIG. 1) on the steerer tube 202 with respect to the front wheel 104 (FIG. 1). In some examples, the alignment markings 251 can include more than one line 304 to indicate to the user various alignments. Further, the line(s) 304 may be of differing lengths, shapes, and orientations than those depicted in FIG. 3. As shown in FIG. 2A, the line 304 extends from the first end 226 of the steerer tube 202 through the last of the lines 300. However, in other examples, the line 304 may only extend through a portion of the first portion 230 of the steerer tube 202 and may not intersect with the lines 300; the line 304 may extend through the first portion 230, the second portion 232, and the third portion 234; or the line 304 may extend any length on the steerer tube 202.

FIG. 6A is a rear side view of the steerer tube 202 with the stem 115 attached to the steerer tube 202. FIG. 6B is an enlarged view of the callout 600 of FIG. 6A. The stem 115 includes the first upper arm 404a, the second upper arm 404b, the first lower arm 406a, and the second lower arm 406b. The first and second upper arms 404a, 404b are connected by first bolt 602a, and the first and second lower arms 406a, 406b are connected by a second bolt 602b. The first bolt 602a can be tightened to move the first and second upper arms 404a, 404b toward each other, and the second bolt 602b can be tightened to move the first and second lower arms 406a, 406b toward each other. This tightening clamps the stem 115 onto the steerer tube 202. As shown in FIG. 6B, a small gap remains between the first and second upper arms 404a, 404b, and a small gap remains between the first and second lower arms 406a, 406b. The line 304 can be used by the user to help align the stem 115 on the steerer tube 202 so that the handlebars 114 (FIG. 1) are properly aligned with the front wheel 104 (FIG. 1). For example, before tightening the stem 115 onto the steerer tube 202, the stem 115 is positioned on the steerer tube 202 such that the line 304 is aligned between (e.g., equidistant between) the first and second upper arms 404a, 404b, and between the first and second lower arms 406a, 406b. This ensures the handlebars 114 will be properly aligned with the front wheel 104. The line 304 does not contact the first and second upper arms 404a, 404b or the first and second lower arms 406a, 406b but is visible through the small gap between the upper and lower arms 404a, 404b and 406a, 406b. The line 304 at least extends along one-third of the length of the gap. In this example, line 304 extends the entire length of the gap between the upper and lower arms of the stem to provide better visibility of the line 304.

FIG. 7A is a top view showing the fork 200 installed on the frame 102 of the bicycle 100 and the stem 115 with the handlebars 114 attached to the steerer tube 202. The steerer tube 202 has a first central axis 700 (extending into/out of the page). The first central axis 700 extends along a first vertical plane 702 (extending into/out of the page) shown in dashed lines. The first and second legs 206, 208 have respective central axes 704a, 704b that form a second vertical plane 706 (extending into/out of the page) shown in dashed lines. The first and second vertical planes 702, 706 are perpendicular. The first vertical plane 702 also corresponds to the plane along which the front wheel 104 (FIG. 1) is aligned when attached to the fork 200. The handlebars 114 have a middle portion 707 with a central axis 708. It is typically desired for this central axis 708 of the handlebars 114 to be aligned perpendicular to the front wheel 104 when viewed from the top view in FIG. 7A. As such, the handlebars 114 are to be positioned such that the central axis 708 of the handlebars 114 is perpendicular to the first plane 702 and/or parallel to the second plane 706. In this example, the line 304 (FIG. 3) can be used to aid the user in positioning the stem 115 on the steerer tube 202 so that the handlebars 114 are perpendicular to the first plane 702 and, thus, perpendicular to the front wheel 104.

FIG. 7B is a rear perspective view of the fork 200, the stem 115, and the handlebars 114 of FIG. 7A. FIG. 7C is an enlarged view of the callout 710 of FIG. 7B. As shown FIG. 7C, the line 304 is aligned with the first vertical plane 702 on the outer surface 252 of the steerer tube 202. As such, the user can easily align the handlebars 114 perpendicular to the first vertical plane 702 (and, thus, the front wheel 104) by centering the line 304 between the arms 404a, 404b, 406a 406b of the stem 115.

Additionally or alternatively, the steerer tube 202 can include vertical lines on either side of the first vertical plane 702. For example, the steerer tube 202 may have 3 vertical lines.

An example method of assembling the fork 200 and applying the markings 250 is disclosed herein. In some examples, the steerer tube 202 and the legs 206, 204 are coupled to the crown 204 first, and then the markings 250 are applied to the steerer tube 202. This helps to ensure the line 304 is aligned along the first vertical plane 702 on the steerer tube 202. Otherwise, if the line 304 was applied to the steerer tube 202 first, it can be difficult to ensure the line 304 is aligned with the first vertical plane 702 when coupling the steerer tube 202 to the crown 204. Also, by assembling the steerer tube 202 and the legs 206, 208 to the crown 204 first, the crown 204 and the legs 206, 208 can be used as fixture points or datum points when applying the markings 250. For example, the markings 250 can be etched using a laser machine.

From the foregoing, it will be appreciated that example systems, apparatus, articles of manufacture, and methods have been disclosed that improve alignment of handlebars onto the steerer tube of bicycles and improve measurement of the steerer tube for cutting by a user.

Example methods, apparatus, systems, and articles of manufacture provide visual indications on bicycle forks to improve alignment of handlebars on a steerer tube and/or improve measurement of the length of the steerer tube are disclosed herein. Further examples and combinations thereof include the following:

Example 1 includes a front fork for a bicycle, the front fork comprising a crown having a top side and a bottom side opposite the top side, at least one first leg coupled to and extending downward from the bottom side of the crown, and a steerer tube coupled to and extending upward from the top side of the crown, the steerer tube having a first marking and a second marking on an outer surface of the steerer tube, the first marking indicating a distance between the first marking and the top side of the crown to enable a user to cut the steering tube to a desired length, the first marking extending in a circumferential direction on the outer surface of the steerer tube, the second marking to be used to align at least one of a stem or handlebars on the steerer tube, the second marking extending in the axial direction and intersecting the first marking.

Example 2 includes the front fork of example 1, wherein the first and second markings are formed by removing material from the outer surface of the steerer tube.

Example 3 includes the front fork of example 2, wherein the first and second markings are etched or engraved into the outer surface of the steerer tube.

Example 4 includes the front fork of example 1, wherein the first and second markings are formed by applying material to the outer surface of the steerer tube.

Example 5 includes the front fork of example 4, wherein the first and second markings are at least one of paint, a sticker, a decal, or a pre-finish masking on the outer surface of the steerer tube.

Example 6 includes the front fork of any of examples 1-4, wherein the first marking perpendicularly intersects the second marking.

Example 7 includes the front fork of any of examples 1-5, wherein the first marking includes a numerical value adjacent the line.

Example 8 includes the front fork of any of examples 1-7, wherein the first marking comprises a plurality of first markings on the outer surface of the steerer tube, the plurality of first markings spaced from each other in an axial direction along the outer surface of the steerer tube, each of the plurality of first markings indicating a distance between the respective marking and the top side of the crown, the second line perpendicularly intersects the plurality of first lines.

Example 9 includes the front fork of any of examples 1-8, wherein the steerer tube has a first portion that is straight and a second portion that is tapered, the first portion extending between the second portion and a top end of the steerer tube, and wherein the first and second markings are on the first portion of the steerer tube.

Example 10 includes the front fork of any of examples 1-9, wherein steerer tube has a rear side to be facing rearward and toward a rider when the front fork is installed on the bicycle, and wherein the first and second markings are on the rear side of the steerer tube.

Example 11 includes the front fork of any of examples 1-10, wherein the first and second markings are a first color and at least a portion of the outer surface of the steerer tube where the first and second markings are formed is a second color different than the first color.

Example 12 includes the front fork of any of examples 1-11, wherein the front fork is a suspension fork.

Example 13 includes a front fork for a bicycle, the front fork comprising a crown having a top side and a bottom side opposite the top side, at least one first leg coupled to and extending downward from the bottom side of the crown, and a steerer tube coupled to and extending upward from the top side of the crown, the steerer tube having a marking on an outer surface of the steerer tube, the marking to be used to align at least one of a stem on the steerer tube, the marking comprising a line extending in an axial direction along the outer surface of the steerer tube such that the line is visible in a gap between ends of the stem when the stem is installed on the steerer tube.

Example 14 includes the front fork of example 13, further comprises a second leg, the steerer tube having a first central axis, the first central axis extending along a first vertical plane, the first leg and the second leg having central axes, the central axes of the first and second legs forming a second vertical plane, the second vertical plane being perpendicular to the first vertical plane, and wherein the line is aligned with the first vertical plane on the outer surface of the steerer tube.

Example 15 includes the front fork of any of examples 13-14, wherein the marking is formed by removing or adding material to the outer surface of the steerer tube.

Example 16 includes the front fork of any of examples 13-15, wherein the marking is etched or engraved into the outer surface of the steerer tube.

Example 17 includes the front fork of any of examples 13-15, wherein the marking is at least one of paint, a sticker, a decal, or a pre-finish masking on the outer surface of the steerer tube.

Example 18 includes the front fork of any of examples 13-17, wherein the steerer tube has a first portion that is straight and a second portion that is tapered, the first portion extending between the second portion and a top end of the steerer tube, and wherein the marking is on the first portion of the steerer tube.

Example 19 includes the front fork of any of examples 13-18, wherein the marking is a first color and at least a portion of the outer surface of the steerer tube wherein the marking is formed is a second color different from the first color.

Example 20 includes the front fork of any of examples 13-19, wherein the front fork is a suspension fork.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A front fork for a bicycle, the front fork comprising:
a crown having a top side and a bottom side opposite the top side;
at least one first leg coupled to and extending downward from the bottom side of the crown; and
a steerer tube coupled to and extending upward from the top side of the crown, the steerer tube having a first marking and a second marking on an outer surface of the steerer tube,
the first marking indicating a distance between the first marking and the top side of the crown to enable a user to cut the steering tube to a desired length, the first marking extending in a circumferential direction on the outer surface of the steerer tube,
the second marking to be used to align at least one of a stem or handlebars on the steerer tube, the second marking extending in an axial direction and intersecting the first marking.

2. The front fork of claim 1, wherein the first and second markings are formed by removing material from the outer surface of the steerer tube.

3. The front fork of claim 2, wherein the first and second markings are etched or engraved into the outer surface of the steerer tube.

4. The front fork of claim 1, wherein the first and second markings are formed by applying material to the outer surface of the steerer tube.

5. The front fork of claim 4, wherein the first and second markings are at least one of paint, a sticker, a decal, or a pre-finish masking on the outer surface of the steerer tube.

6. The front fork of claim 1, wherein the first marking perpendicularly intersects the second marking.

7. The front fork of claim 6, wherein the first marking includes a numerical value adjacent a first line.

8. The front fork of claim 1, wherein the first marking comprises a plurality of first lines on the outer surface of the steerer tube, the plurality of first lines spaced from each other in an axial direction along the outer surface of the steerer tube, each of the plurality of first lines indicating a distance between the respective line and the top side of the crown, the second marking comprising a second line intersecting the plurality of first lines, the second line perpendicularly intersects the plurality of first lines.

9. The front fork of claim 1, wherein the steerer tube has a first portion that is straight and a second portion that is tapered, the first portion extending between the second portion and a top end of the steerer tube, and wherein the first and second markings are on the first portion of the steerer tube.

10. The front fork of claim 9, wherein the steerer tube has a rear side to be facing rearward and toward a rider when the front fork is installed on the bicycle, and wherein the first and second markings are on the rear side of the steerer tube.

11. The front fork of claim 1, wherein the first and second markings are a first color and at least a portion of the outer surface of the steerer tube where the first and second markings are formed is a second color different than the first color.

12. The front fork of claim 1, wherein the front fork is a suspension fork.

13. A front fork for a bicycle, the front fork comprising:
a crown having a top side and a bottom side opposite the top side;
at least one first leg coupled to and extending downward from the bottom side of the crown; and
a steerer tube coupled to and extending upward from the top side of the crown, the steerer tube having a marking on an outer surface of the steerer tube used to align a stem on the steerer tube, the marking comprising a line extending in an axial direction along the outer surface of the steerer tube such that the line is visible in a gap between ends of the stem when the stem is installed on the steerer tube.

14. The front fork of claim 13, further comprises a second leg, the steerer tube having a first central axis, the first central axis extending along a first vertical plane, the first leg and the second leg having central axes, the central axes of the first and second legs forming a second vertical plane, the second vertical plane being perpendicular to the first vertical plane, and wherein the line is aligned with the first vertical plane on the outer surface of the steerer tube.

15. The front fork of claim 13, wherein the marking is formed by removing or adding material to the outer surface of the steerer tube.

16. The front fork of claim 15, wherein the marking is etched or engraved into the outer surface of the steerer tube.

17. The front fork of claim 15, wherein the marking is at least one of paint, a sticker, a decal, or a pre-finish masking on the outer surface of the steerer tube.

18. The front fork of claim 13, wherein the steerer tube has a first portion that is straight and a second portion that is tapered, the first portion extending between the second portion and a top end of the steerer tube, and wherein the marking is on the first portion of the steerer tube.

19. The front fork of claim 13, wherein the marking is a first color and at least a portion of the outer surface of the steerer tube where the marking is formed is a second color different than the first color.

20. The front fork of claim 13, wherein the front fork is a suspension fork.
